(19) United States
(12) Patent Application Publication
(10) Pub. No.: US 2012/0261912 A1
(43) Pub. Date: Oct. 18, 2012

(54) AIRBAG MODULE FOR A MOTOR VEHICLE

(75) Inventor: Steffen WEIGAND, Aschaffenburg (DE)

(73) Assignee: TAKATA AG

(21) Appl. No.: 13/530,080

(22) Filed: Jun. 21, 2012

Related U.S. Application Data
(63) Continuation of application No. PCT/EP2010/070235, filed on Dec. 20, 2010.

(30) Foreign Application Priority Data
Dec. 23, 2009 (DE) 10 2009 055 266.9

(51) Int. Cl. B60R 21/26

(52) U.S. Cl. 280/736

(57) ABSTRACT

An airbag module for a motor vehicle is provided. The airbag module comprising a gasbag inflatable for the protection of a person, a band interacting with the gasbag, a carrier of the airbag module, a holding element via which the band is attached to the carrier and a motion generating device. The holding element is integrally formed with the carrier such that it can be separated from the carrier for releasing the band upon impact of a predeterminable force on the holding element. The motion generating device is configured and provided for blasting off the complete holding element from the carrier for releasing the band.

This application is a continuation of International Patent Application Number PCT/EP2010/070235, filed on Dec. 20, 2010, which was published in German as WO 2011/076733. The foregoing international application is incorporated by reference herein.

### BACKGROUND

The invention relates to an airbag module for a motor.

Such an airbag module comprises a gasbag which can be inflated for the protection of a person, a band interacting with the gasbag which in particular is formed flexible and may extend longitudinally, a carrier of the airbag module for carrying components of the airbag module and a holding element, via which said band is fixed to the carrier.

### SUMMARY

It is an object of the invention to provide such an airbag module which can be fabricated cost effectively and in a simple manner.

According to an exemplary embodiment of the invention the holding element is integrally formed on the carrier. The carrier and the holding element formed thereon can be moulded from plastic (e.g. injection moulding) or a metal or can be formed in any other way. Further, the holding element is formed on the carrier in such a way that the holding element is separated from the carrier and releases the band when a predetermined force impacts on the holding element, i.e. the band is not fixed to the carrier anymore.

Exemplary, the holding element is connected to the carrier via a predetermined breaking connection (also called predetermined breaking point) which e.g. is formed by a circumferential weakening line. Such a weakening line, for example, is formed by providing less material of the carrier and the holding element, respectively, in the region of said line and of the interface between the holding element and the actual carrier (in sections), respectively, than in the surroundings of said line such that the holding element will be separated from the carrier along this predetermined braking point (weakening line) under the impact of said force.

Exemplary, the holding element furthermore protrudes from the carrier, in particular along an extension direction of the holding element, which in particular runs opposite a main unfolding direction, along which the gasbag unfolds for the protection of a person. The holding element thus in particular is formed as an elevation or a recess of the carrier.

In this sense, the holding element thus preferably comprises a circumferential side wall via which it is formed on the carrier, and furthermore a bottom from which said side wall protrudes. In particular, said predetermined breaking point is provided at the bottom of said side wall, i.e. at the interface between carrier and side wall and preferably circulates accordingly.

Exemplary, the band is placed around the holding element for being fixed to the carrier, in particular around its side wall, such that it surrounds the holding element and its side wall, respectively. For this, the band exemplarily can comprise a loop surrounding the side wall of the holding element. In case the holding element is separated from the carrier, the band thus is released and no longer fixed to the carrier.

For separating the holding element from the carrier, preferably a motion generating device is provided, in particular in the form of a gas generator, which is configured and provided for detaching the holding element from the carrier, i.e. in particular for destroying the predetermined breaking point for separating the holding element.

For this, the holding element exemplary comprises a through opening which preferably is provided in the bottom of the holding element, in which the motion generating device is introduced such that said side wall of the holding element surrounds said motion generating device in cross-section.

This permits the motion generating device to exert a force on the holding element after activation in such a way that the holding element is separated from the carrier along said predetermined breaking point, in particular together with the motion generating device.

For fixing the motion generating device in said through opening of the holding element in particular a clamping element is provided which can be fixed at the carrier in such a way that it presses a contact section of the motion generating device against the holding element and in particular covers or closes the through opening. Thus, said contact section in particular is pressed against a rim section of the bottom of the holding element delimiting the through opening.

Exemplary, at least one bolt protrudes from the clamping element which reaches through an assigned opening of the carrier for fixing the carrier to the clamping element, wherein said bolt in particular can be screwed with a nut which presses the carrier against the clamping element. Further, said clamping element can be configured and provided as a diffuser for creating vortexes of gases to be guided into the gasbag and for this can comprise a cap-like region with cut-throughs through which the gas can enter into the gasbag.

Said carrier of the airbag module according to the invention in particular is configured to carry a (further) gas generator for inflating the gasbag of the airbag module. Preferably, the carrier comprises a bottom and a circumferential side wall protruding from it, wherein said bottom in particular comprises a generator opening for receiving said (further) gas generator. Preferably, the holding element is formed at the bottom of the carrier or connected to it via a predetermined breaking connection.

The band initially fixed to the carrier in particular is configured and provided in such a way that it interacts with functional components of the gasbag by means of which the gasbag can be adapted to the person to be protected. For example, the band in particular interacts with at least one outlet opening of the gasbag such that the open cross section of said at least one outlet opening is enlarged or reduced when the band is released by the holding element, e.g. during inflation of the gasbag.

### BRIEF DESCRIPTION OF THE DRAWINGS

The described features and advantages of the invention shall be illustrated by means of the following description of figures of an embodiment.

FIGS. 1-2: show a perspective view of a clamping metal sheet of an airbag module according to the invention which is deposited in a covering cap of the airbag module.

FIG. 3: shows a perspective view of a carrier of an airbag module according to the invention which is arranged on the clamping metal sheet.

FIG. 4: shows a schematic sectional view of an airbag module according to the invention before activation of the motion generating device for detaching a holding element for a band of the airbag module.

FIG. 5: shows a further schematic sectional view of the airbag module shown in FIG. 1 upon activation of the motion generating device.

FIG. 6: shows a further schematic sectional view of the airbag module shown in FIGS. 1 and 2 with a detached holding element and a released band

FIG. 7: shows a schematic, detailed view-like sectional view of an airbag module according to the invention, wherein the band covers an outlet opening of the gasbag.

### DETAILED DESCRIPTION

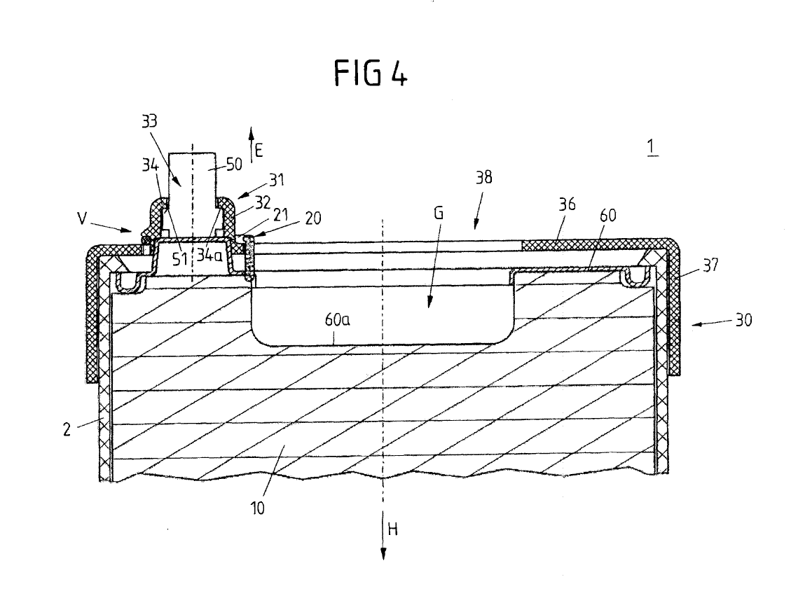

FIG. 4 in connection with the other Figures depicts in cross section an airbag module 1 according to the invention in form of a driver airbag module, wherein the main unfolding direction H of a gasbag 10 of the airbag module 1, along which the gasbag unfolds towards a person to be protected during inflation, lies in the cross sectional plane according to FIG. 4.

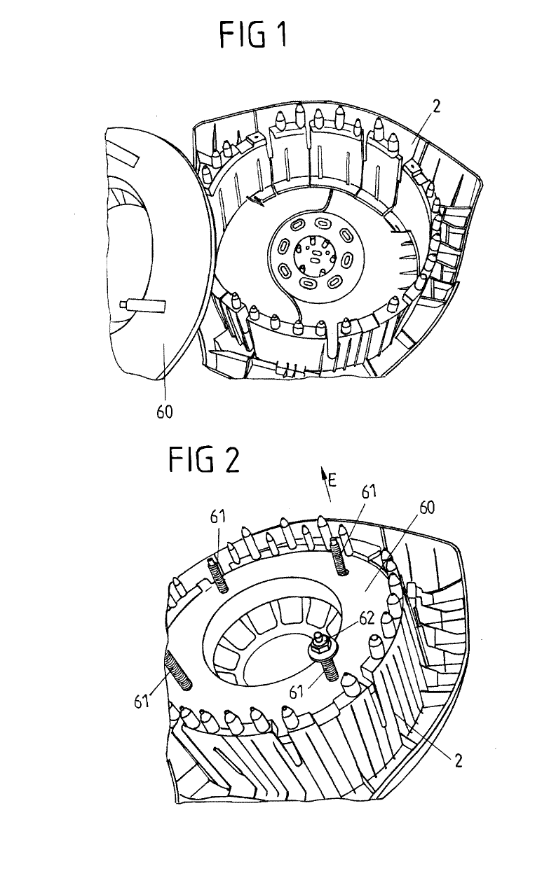

The airbag module 1 comprises a covering cap 2 covering the gasbag 10 of the airbag module before inflation (see FIG. 1) and a carrier 30 for carrying a gas generator G configured for inflating the gasbag 10.

The carrier 30 comprises, a, in particular circular, bottom 36 having a central generator opening 38 for receiving the gas generator G (not shown in the Figures) and a wall 37 circulating transverse with respect to the main unfolding direction H, the wall 37 protruding from an outer edge of bottom 36 and extending along the main unfolding direction H.

A holding element 31 is integrally formed with the carrier 30 at the bottom 36 of the carrier 30 via a predetermined breaking connection V such that the carrier in the region of said holding element forms a recess or an elevation (formed by the holding element). That is, the holding element 31 protrudes from the bottom 36 of the carrier 30 along an extension direction E opposite the main unfolding direction H.

The holding element 31 comprises a circumferential sidewall 32 via which it is formed on the bottom 36 of the carrier (adjacent to the generator opening 38), i.e. said sidewall in particular is formed on the bottom 36 of the carrier via said predetermined breaking connection V. The sidewall 32 of the holding element 31 protrudes from a bottom 34 of the holding element 31 in which a central through opening 33 for receiving a motion generating device 50 is provided.

A contact region 51 of the motion generating device 50 is pressed against an edge region 34a of the bottom 34 of the holding element 31 delimiting the through opening 33 of holding element 31 by means of a clamping element 60 (see FIGS. 1 and 2) such that said clamping element simultaneously shields the motion generating device 50 with respect to the gasbag 10. For this, the clamping element 60 can comprise a protrusion towards the motion generating device in the region of the motion generating device 50, i.e., in the extension direction E which presses the motion generating device in the trough opening 33 and against said edge region 34a, respectively, as soon as the carrier 30 is fixed at the clamping element 60. For this, the clamping element 60 according to FIG. 2 comprises bolts 61 protruding from the clamping element 60 in the extension direction E, the bolts being inserted into corresponding openings 35 of carrier 30 and, for example, are screwed with nuts 62 such that they pretension the carrier 30 against the clamping sheet 60.

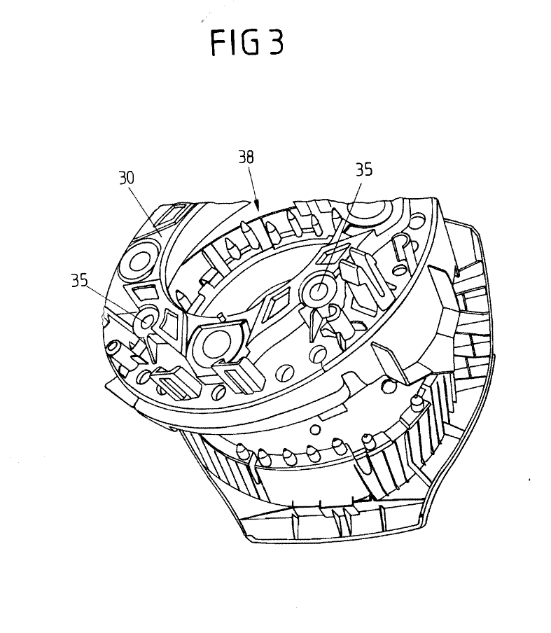

The assembly of clamping sheet 60 and carrier 30 is exemplarily shown in FIGS. 1 to 3. Accordingly, at first the clamping sheet 60 is deposited in the covering cap 2 of the airbag module 1 (the folded gasbag 10 is not shown in FIGS. 1 and 2). Subsequently, the carrier 30 and the motion generating device 50 (not shown in FIG. 3) is arranged on the clamping element 60 and assembled as set forth above. According to FIGS. 3 and 4 to 6, the clamping sheet 60 can also have the function of a diffuser. For this, the clamping sheet 60 comprises a central cap-like region 60a with apertures through which gas released by the gas generator G can flow into the gasbag 10.

Furthermore, the clamping sheet 60 in particular also presses the airbag cap 2 against the bottom 36 of the carrier after having been screwed to the carrier according to FIGS. 4 to 6. Further, also the gas bag 10, i.e. a circumferential edge region of an inlet opening of the gas bag 10, can be pressed against a part of the airbag module 1, in particular against the carrier 30, by means of the clamping sheet 60 in order to fix the gas bag 10 in the airbag module 1.

The motion generating device 50 in particular is provided as a so-called micro gas generator which can be ignited (activated) electrically by means of a suitable control device and which then pyrotechnically provides an acceleration. The acceleration acts in such a way that the motion generating device 50 transmits a force on the holding element 31 that tears apart the predetermined breaking connection V and that detaches the holding element 31 from the bottom 36 of carrier 30 opposite the main unfolding direction H, that is, in the extension direction E.

By this, a band 20 coming from the gas bag 10 and in particular being guided through the generator opening 38 and being placed around the holding element 31, i.e. around its sidewall 32 such that tensioning the band 20 in the main unfolding direction H pushes the band 20 against the sidewall 32 of the holding element 31 and thus fixes the band 20 at the carrier 30, is separated from the holding element 31 and thus released.

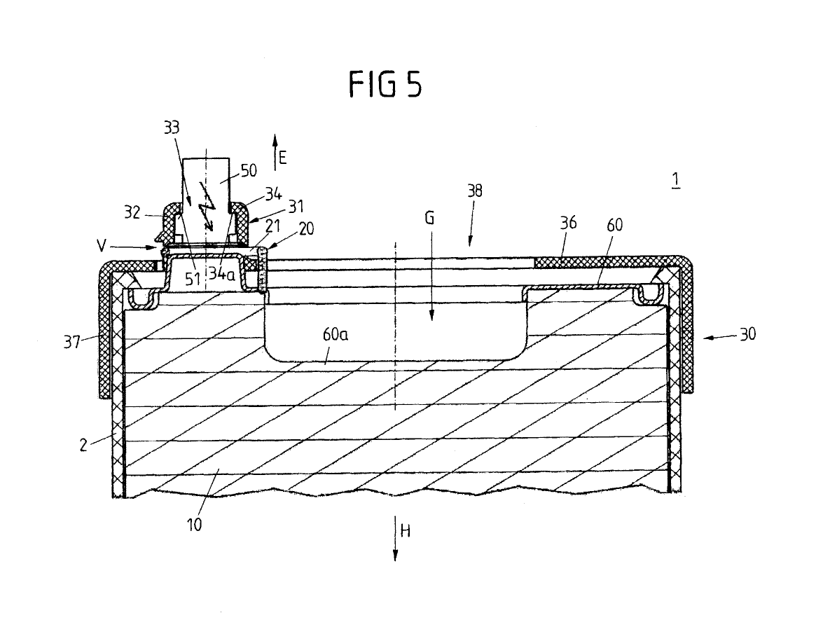

The activation of the motion generating device 50 is schematically indicated by a bolt in FIG. 5, wherein in FIG. 5 the holding element 31 is already separated from carrier 30.

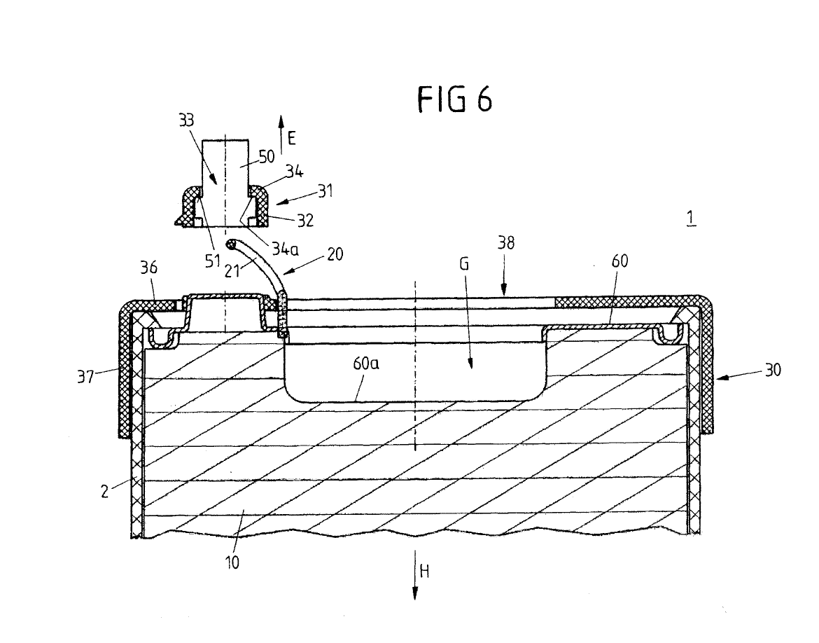

Thereby, according to FIG. 6, the band is released, the band exemplarily having a longitudinal shape forming a closed loop 21 with a free end which is initially placed around the holding element 31 and its sidewall 32 such that said loop extends around the holding element 31 in cross section.

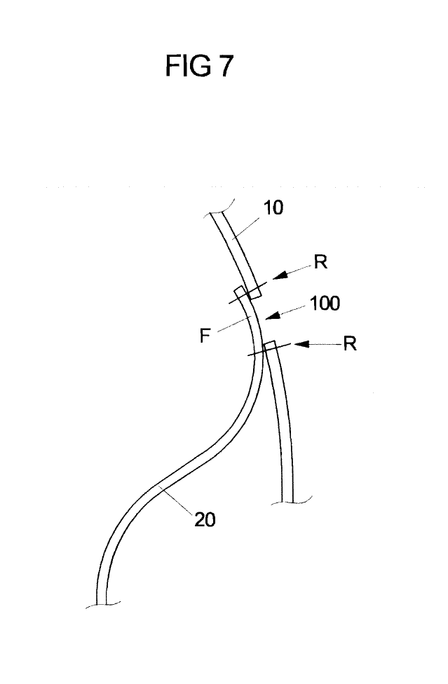

Another free end F interacts with the gasbag 10. For example, the other free end F of band 20 according to FIG. 7 can be attached to a covering of an outlet opening 100 of the gasbag 10 or may itself form such a covering such that the band 20 is tensioned during inflation of the gasbag 10 and pulls away said covering (free end F) for allowing gas to flow out of the gas bag 10 in case the motion generating device 50 is not activated to release the band 20. The free end F can be initially attached to the outlet opening 100 in a suited manner, for example by means of a tear seam R, an adhesive connection or any other connection. The free end F (covering) can be attached at gasbag 10 at an inside or also partially outside the gas bag 10 wherein it may be lead out of the outlet opening 100. If the holding element 31 is not separated during inflation of the gas bag 10, the band 20 will be pretensioned during inflation of gasbag 10 and the free end F (covering element) will be separated from the outlet opening 100, wherein said connection R will be released. In this manner, a controllable venting of the gas bag 10 is possible.

Other control mechanisms wherein the gas bag 10 is adapted to the person to be protected or other circumstances via the band 20 are also conceivable.

The priority application, German Patent Application Number 10 2009 055 266.9, filed on Dec. 23, 2009 is incorporated by reference herein.

1. An airbag module for a motor vehicle, comprising
a gasbag inflatable for the protection of a person,
a band interacting with the gasbag,
a carrier of the airbag module,
a holding element via which the band is attached to the carrier, wherein the holding element is integrally formed with the carrier such that it can be separated from the carrier for releasing the band upon impact of a predeterminable force on the holding element, and
a motion generating device which is configured and provided for blasting off the complete holding element from the carrier for releasing the band.

2. The airbag module according to claim 1, wherein the holding element is formed on the carrier via a predetermined breaking connection.

3. The airbag module according to claim 1, wherein the holding element protrudes from the carrier.

4. The airbag module according to claim 1, wherein the holding element comprises a circumferential sidewall via which it is formed on the carrier.

5. The airbag module according to claim 1, wherein the band is placed around the holding part, in particular around its sidewall, for being attached to the carrier.

6. The airbag module according to claim 1, wherein the motion generating device is provided in form of a gas generator.

7. The airbag module according to claim 1, wherein the holding element comprises a through opening in which the motion generating device is inserted.

8. The airbag module according to claims 1, further comprising a clamping element which is attached to the carrier in such a way that it presses a contact region of the motion generating device against the holding element for fixing the motion generating device to the holding element.

9. The airbag module according to claim 8, wherein the contact section is pressed against an edge region of the holding element delimiting the through opening.

10. The airbag module according to claim 8, wherein at least one bolt protrudes from the clamping element which reaches through an assigned opening of the carrier for attaching the carrier at the clamping element, wherein said bolt can be screwed, in particular via a nut which presses the carrier against the clamping element.

11. The airbag module according to claim 8, wherein the clamping element is formed as a diffuser for vortexing gases to be discharged into the gas bag.

12. The airbag module according to claim 1, wherein the carrier is configured for carrying a further gas generator for inflating the gas bag.

13. The airbag module according to claim 1, wherein the carrier comprises a bottom and a circumferential wall protruding therefrom, wherein the bottom in particular comprises a generator opening for receiving the further gas generator.

14. The airbag module according to claim 13, wherein the holding element is formed on the bottom of the carrier.

15. The airbag module according to claim 1, wherein the band interacts with at least one outlet opening of the gas bag such that the opening cross section of said at least one outlet opening is enlarged or reduced when the band is released by the holding element.
